(19) United States
(12) Patent Application Publication
(10) Pub. No.: US 2025/0349941 A1
(43) Pub. Date: Nov. 13, 2025

(54) INSULATION SHEET AND SECONDARY BATTERY MODULE

(71) Applicant: SAMSUNG SDI CO., LTD., Yongin-si (KR)

(72) Inventors: Jung Hyo LEE, Suwon-si (KR); A Rum YU, Suwon-si (KR); Myung Heui WOO, Suwon-si (KR); Seung Yong YANG, Suwon-si (KR); Hye Jin PARK, Suwon-si (KR); Jae Hyun LEE, Suwon-si (KR); Ha Na RA, Suwon-si (KR); Yun Sung YANG, Suwon-si (KR)

(73) Assignee: SAMSUNG SDI CO., LTD., Yongin-si (KR)

(21) Appl. No.: 19/089,483

(22) Filed: Mar. 25, 2025

(30) Foreign Application Priority Data
May 9, 2024 (KR) 10-2024-0060989

(51) Int. Cl. H01M 10/658; H01M 10/647

(52) U.S. Cl. CPC H01M 10/658; H01M 10/647

(57) ABSTRACT

The present disclosure relates to an insulation sheet and a battery module including the insulation sheet. The insulation sheet includes one or more first layers, and one or more second layers alternately stacked with the one or more first layers, wherein the one or more second layers include an insulating material and an impact-resistant resin.

### CROSS-REFERENCE TO RELATED APPLICATION

The present application claims priority to Korean Patent Application No. 10-2024-0060989, filed on May 9, 2024 in the Korean Intellectual Property Office, and the entire disclosure of which is incorporated herein by reference.

### BACKGROUND

### 1. Field of the Disclosure

The present disclosure relates to an insulation sheet and a secondary battery module including the insulation sheet.

### 2. Description of the Related Art

With increasing presence of electronic devices that use batteries, such as, e.g., mobile phones, laptop computers, electric vehicles, and the like, demand for secondary batteries with high energy density and high capacity has been increasing. Accordingly, improving performance of lithium secondary batteries may be advantageous.

Lithium secondary batteries include a positive electrode and a negative electrode, each containing active materials capable of intercalation and deintercalation of lithium ions and an electrolyte, and the lithium secondary batteries generate electrical energy through oxidation and reduction reactions when lithium ions are intercalated/deintercalated in the positive and negative electrodes.

With recent advances in technology and/or increased concern about the environment, the number of application areas of such secondary batteries is increasing. Accordingly, demand for high capacity secondary batteries is also increasing.

High capacity secondary batteries are formed as a module and/or a pack in which a plurality of secondary batteries are stacked. However, because the plurality of secondary batteries are disposed adjacent to each other, there may be heat transfer between adjacent cells. When thermal runaway occurs in one cell, the thermal runaway readily propagates to adjacent cells, thereby causing safety risks such as fire.

Therefore, improving heat transfer between adjacent cells may be advantageous.

### SUMMARY

One example embodiment includes an insulation sheet and/or a secondary battery module including the insulation sheet, reducing or preventing heat transfer.

One example embodiment includes an insulation sheet and/or a secondary battery module including the insulation sheet, having a desired or improved impact resistance property.

One example embodiment includes an insulation sheet and/or a secondary battery module including the insulation sheet, having improved uniformity of a coating layer.

One example embodiment includes an insulation sheet and/or a secondary battery module including the insulation sheet, having improved thermal conductivity.

One example embodiment includes an insulation sheet and/or a secondary battery module including the insulation sheet, having improved fire resistance and/or mechanical strength.

According to one example embodiment, an insulation sheet includes one or more first layers, and one or more second layers alternately stacked with the one or more first layers, wherein the one or more second layers include an insulating material and an impact-resistant resin.

According to another example embodiment, a battery module includes a plurality of battery cells, the above-described insulation sheet located in at least one of a plurality of locations between the plurality of battery cells, and a housing in which the battery cells and the insulation sheet are accommodated.

### BRIEF DESCRIPTION OF THE DRAWINGS

The following drawings attached to the present specification illustrate example embodiments of the present disclosure and serve to further understanding of the technical spirit of the present disclosure along with the detailed description described below, and therefore the present disclosure should not be interpreted as being limited to the matters described in such drawings:

FIGS. 1 to 4 are views schematically showing a lithium secondary battery according to one example embodiment;

FIG. 5 is a view showing a battery module according to one example embodiment;

FIG. 6 is a perspective view of a battery cell according to one example embodiment;

FIG. 7 is a cross-sectional view of an insulation sheet according to one example embodiment;

FIG. 8 is a cross-sectional view of an insulation sheet according to one example embodiment;

FIG. 9 is a cross-sectional view of an insulation sheet according to one example embodiment;

FIG. 10 is a cross-sectional view of an insulation sheet according to one example embodiment;

FIG. 11 is a cross-sectional view of an insulation sheet according to one example embodiment; and

FIG. 12 is a cross-sectional view of an insulation sheet according to one example embodiment.

### DETAILED DESCRIPTION

Hereinafter, example embodiments of the present disclosure are described in detail. However, these embodiments are presented as examples, the present disclosure is not limited thereby, and the present disclosure is only defined by the scope of the claims described below.

Unless otherwise specified in the present application, when a part such as a layer, membrane, region, or plate is stated to be “on” other part, this refers not only to the case where it is “directly above” the other part, but also to the case where there is another part interposed therebetween.

Unless otherwise specified in the present specification, a singular may also include a plural. In addition, unless otherwise specified, “A or B” may indicate “including A, including B, or including A and B.”

As included herein, “a combination thereof” may indicate a mixture, a laminate, a composite, a copolymer, an alloy, a blend, or a reaction product of constituents, and the like.

Unless otherwise defined in the present application, a particle diameter may be an average particle diameter. In addition, the particle diameter is the average particle diameter D50 which refers to diameters of particles whose cumulative volumes are 50 volume % in a particle size distribution. The average particle diameter D50 may be measured by a method known to those skilled in the art, for example, a particle diameter analyzer, a transmission electron microscope, or a scanning electron microscope. As another method, the average particle diameter D50 value may be obtained by measuring the particle diameters using a measuring device using dynamic light-scattering, conducting data analysis, counting the number of particles for each particle diameter range, and then calculating the average particle diameter therefrom. Alternatively, the average particle diameter may be measured using a laser diffraction method. When measuring the average particle diameter by the laser diffraction method, for example, the average particle diameter D50 based on 50% of the particle diameter distribution in the measuring device may be calculated by dispersing the particles to be measured in a dispersing medium, then introducing the particles into a commercially available laser diffraction particle diameter measurement device (e.g., Microtrac's MT 3000), and applying ultrasonic waves of about 28 kHz with a power output of 60 W.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

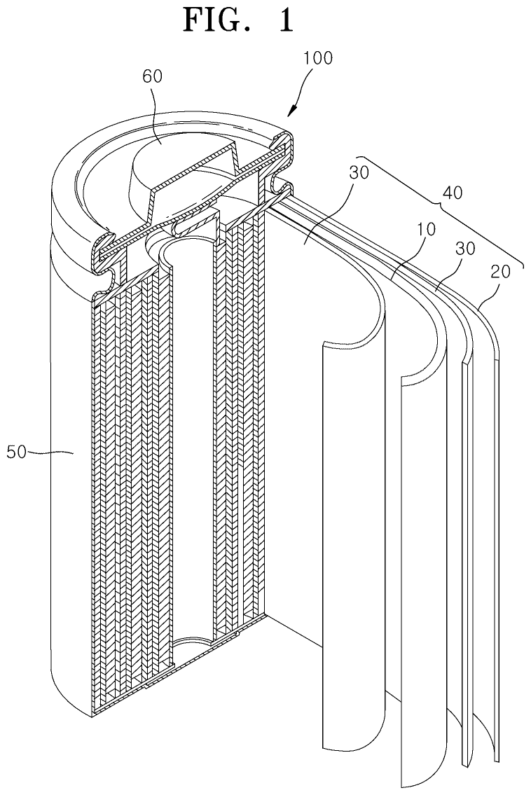

FIGS. 1 to 4 are views schematically illustrating a lithium secondary battery according to one example embodiment.

### Lithium Secondary Battery 100

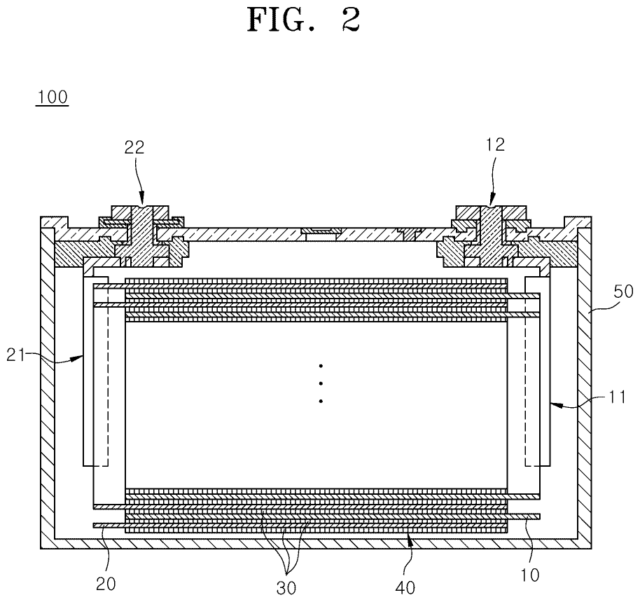

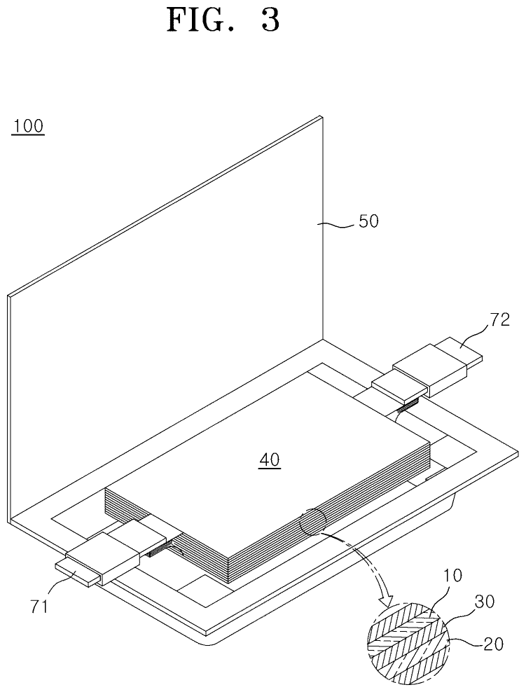

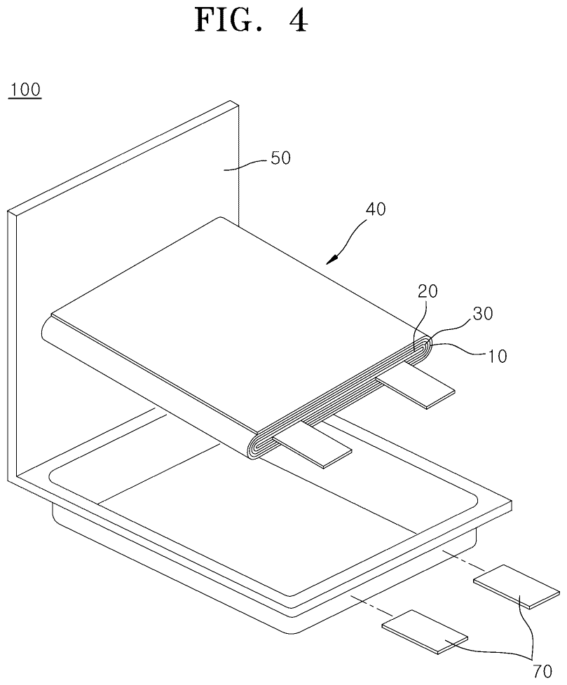

The lithium secondary battery 100 may be classified as a cylindrical shape, a prismatic shape, a pouch shape, a coin shape, and the like, depending on the shape thereof. FIGS. 1 to 4 are schematic views illustrating the lithium secondary battery, according to one example embodiment, where FIG. 1 shows a cylindrical battery, FIG. 2 shows a prismatic battery, and FIGS. 3 and 4 show a pouch-shaped battery. Referring to FIGS. 1 to 4, the lithium secondary battery 100 may include an electrode assembly 40 with a separator 30 interposed between a positive electrode 10 and a negative electrode 20, and a case 50 in which the electrode assembly 40 is housed. The positive electrode 10, the negative electrode 20, and the separator 30 may be impregnated with an electrolyte (not shown). The lithium secondary battery 100 may include a sealing member 60 for sealing the case 50 as shown in FIG. 1. In FIG. 2, the lithium secondary battery 100 may include a positive electrode lead tab 11, a positive electrode terminal 12, a negative electrode lead tab 21, and a negative electrode terminal 22. As shown in FIGS. 3 and 4, the lithium secondary battery 100 may include an electrode tab 70 illustrated in FIG. 4, or a positive electrode tab 71 and a negative electrode tab 72 illustrated in FIG. 3, the electrode tabs 70/71/72 forming an electrical passage to guide a current generated from the electrode assembly 40 to the outside of the battery 100.

### Positive Electrode Active Material

As a positive electrode active material, a compound capable of reversible intercalation and deintercalation of lithium (a lithiated intercalation compound) may be included. For example, at least one of composite oxides of a metal such as or including at least one of cobalt, manganese, nickel, and a combination thereof, and lithium, may be included as the positive electrode active material.

The composite oxide may be or include a lithium transition metal composite oxide, and examples may include at least one of a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following chemical formulas may be included. LiₐA_{1-b}X_{b}O_{2-c}D_{c} (0.90≤a≤1.8, 0≤b≤0.5, 0≤c≤0.05); LiₐMn_{2-b}X_{b}O_{4-c}D, (0.90≤a≤1.8, 0≤b≤0.5, 0≤c≤0.05); LiₐNi_{1-b-c}Co_{b}X_{c}O₂₋ₐDₐ (0.90≤a≤1.8, 0≤b≤0.5, 0≤c≤0.5, 0≤a≤2); LiₐNi_{1-b-c}Mn_{b}X_{c}O₂₋ₐDₐ (0.90≤a≤1.8, 0≤b≤0.5, 0≤c≤0.5, 0≤a≤2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiGbO₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂GbO₄ (0.90≤a≤1.8, 0.001≤b≤0.1); LiₐMn_{1-g}GgPO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

As an example, the positive electrode active material may be or include a high nickel-based positive electrode active material with a nickel content in a range of about 80 mol % or more, 85 mol % or more, 90 mol % or more, 91 mol % or more, or 94 mol % or more and 99 mol % or less based on 100 mol % of a metal excluding lithium from the lithium transition metal composite oxide. The high nickel-based positive electrode active material can realize high capacity, and thus can be included in high capacity, high density lithium secondary batteries.

### Positive Electrode 10

The positive electrode 10 for the lithium secondary battery 100 may include a current collector, and a positive electrode active material layer formed on the current collector. The positive electrode active material layer may include the positive electrode active material, and may further include a binder and/or a conductive material.

As an example, the positive electrode may further include an additive that may be configured as a sacrificial positive electrode.

The content of the positive electrode active material may range from about 90 wt % to about 99.5 wt % based on 100 wt % of the positive electrode active material layer, and the contents of the binder and the conductive material may each range from about 0.5 wt % to about 5 wt % based on 100 wt % of the positive electrode active material layer.

The binder may be configured to attach the positive electrode active material particles to each other, and to attach the positive electrode active material to the current collector. Representative examples of the binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinyl pyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, and the like, but are not limited thereto.

The conductive material may be included to impart conductivity to the electrode, and in a configured battery, any electronically conductive material that does not cause a chemical change may be included. Examples of the conductive material may include a carbon-based material such as at least one of natural graphite, artificial graphite, carbon black, acetylene black, Ketjen black, carbon fibers, carbon nanofibers, carbon nanotubes; a metal-based material containing copper, nickel, aluminum, silver, and the like, in the form of a metal powder or metal fiber; a conductive polymer such as a polyphenylene derivative; or a mixture thereof.

Al may be included as the current collector, but it is not limited thereto.

### Negative Electrode Active Material

The negative electrode active material may include at least one of a material capable of reversible intercalation/deintercalation of lithium ions, lithium metal, an alloy of lithium metal, a material capable of doping and dedoping lithium, or a transition metal oxide.

The material capable of reversible intercalation/deintercalation of lithium ions may be or include a carbon-based negative electrode active material, and may include, for example, crystalline carbon, amorphous carbon, or a combination thereof. Examples of the crystalline carbon may include graphite, such as amorphous, plate-like, flake, spherical, or fibrous natural graphite or artificial graphite, and examples of the amorphous carbon may include at least one of soft carbon, hard carbon, mesophase pitch carbide, calcined coke, and the like.

As the alloy of lithium metal, an alloy of lithium and a metal such as or including at least one of Na, K, Rb, Cs, Fr, Be, Mg, Ca, Sr, Si, Sb, Pb, In, Zn, Ba, Ra, Ge, Al, and Sn may be included.

As the material capable of doping and dedoping lithium, at least one of a Si-based negative electrode active material or a Sn-based negative electrode active material may be included. The Si-based negative electrode active material may include at least one of silicon, a silicon-carbon composite, SiOₓ (0<x<2), a Si-Q alloy (Qis or includes at least one of an alkali metal, an alkaline earth metal, a group 13 element, a group 14 element (excluding Si), a group 15 element, a group 16 element, a transition metal, a rare earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to one example embodiment, the silicon-carbon composite may be in the form of silicon particles, and amorphous carbon coated on surfaces of the silicon particles. For example, the silicon-carbon composite may include a secondary particle (core) in which silicon primary particles are assembled, and an amorphous carbon coating layer (shell) located on a surface of the secondary particle. The amorphous carbon may also be located between the silicon primary particles, for example, the silicon primary particles may be coated with the amorphous carbon. The secondary particle may be dispersed in an amorphous carbon matrix.

The silicon-carbon composite may further include crystalline carbon. For example, the silicon-carbon composite may include a core containing crystalline carbon and silicon particles, and an amorphous carbon coating layer located on a surface of the core.

The Si-based negative electrode active material or the Sn-based negative electrode active material may be included in combination with a carbon-based negative electrode active material.

### Negative Electrode 20

The negative electrode 20 for the lithium secondary battery 100 may include a current collector, and a negative electrode active material layer located on the current collector. The negative electrode active material layer may include a negative electrode active material, and may further include a binder and/or a conductive material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may be configured to attach the negative electrode active material particles, and to attach the negative electrode active material to the current collector. The binder may be or include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide-imide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, fluororubber, a polyethylene oxide, polyvinylpyrrolidone, polyepichlorohydrin, polyphosphazene, poly(meth)acrylonitrile, an ethylene propylene diene monomer copolymer, polyvinylpyridine, chlorosulfonated polyethylene, latex, a polyester resin, a (meth)acrylic resin, a phenolic resin, an epoxy resin, polyvinyl alcohol, and a combination thereof.

When the aqueous binder is included as the negative electrode binder, a cellulose-based compound may be further included to impart viscosity. This cellulose-based compound may be included by mixing one or more of carboxymethyl cellulose, hydroxypropyl methyl cellulose, methyl cellulose, or an alkali metal salt of one of these. As the alkali metal, at least one of Na, K, or Li may be included.

The dry binder is or includes a polymer material that may be fiberized, such as at least one of polytetrafluoroethylene, polyvinylidene fluoride, a polyvinylidene fluoride-hexafluoropropylene copolymer, polyethylene oxide, or a combination thereof.

The conductive material may be included to impart conductivity to the electrode, and in a configured battery, any electronically conductive material that does not cause a chemical change to the battery may be included. Examples of the conductive material may include a carbon-based material such as at least one of natural graphite, artificial graphite, carbon black, acetylene black, Ketjen black, carbon fibers, carbon nanofibers, carbon nanotubes; a metal-based material including at least one of copper, nickel, aluminum, silver, and the like, in the form of a metal powder or metal fiber; a conductive polymer such as or including a polyphenylene derivative; or a mixture thereof.

As the negative electrode current collector, at least one of a copper foil, a nickel foil, a stainless steel foil, a titanium foil, a nickel foam, a copper foam, a conductive metal-coated polymer substrate, and a combination thereof may be included.

### Electrolyte (not Shown)

The electrolyte for the lithium secondary battery 100 may include a non-aqueous organic solvent and a lithium salt.

The non-aqueous organic solvent may be configured as a medium through which ions involved in the electrochemical reaction of the battery may move.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone and the like. As the alcohol-based solvent, at least one of ethyl alcohol, isopropyl alcohol, and the like may be included, and as the aprotic solvent, at least one of a nitrile-based one such as R—CN (R is a straight, branched, or ring-shaped hydrocarbon group having 2 to 20 carbon atoms, and may include a double bond, an aromatic ring, or an ether group); an amide-based one such as dimethylformamide; a dioxolane-based one such as 1,3-dioxolane or 1,4-dioxolane; a sulfolane-based one, and the like may be included.

The non-aqueous organic solvent may be included alone, or in a combination of two or more solvents.

In examples, when using a carbonate-based solvent, a ring-shaped carbonate and a chain-shaped carbonate may be included by being mixed, and the ring-shaped carbonate and the chain-shaped carbonate may be mixed in a volume ratio in a range of about 1:1 to about 1:9.

The lithium salt is or includes a substance that may be dissolved in the organic solvent, and may act as a source of lithium ions within the battery, enabling a basic operation of the lithium secondary battery and promoting the movement of lithium ions between the positive electrode and the negative electrode. Representative examples of the lithium salt may include one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI)), LiC₄F₉SO₃, LiN(CₓF₂ₓ₊₁SO₂)(C_{y}F_{2y+1}SO₂) (x and y are integers from 1 to 20), lithium trifluoromethanesulfonate, lithium tetrafluoroethanesulfonate, lithium difluorobis(oxalato)phosphate (LiDFOB), and lithium bis(oxalato) borate (LiBOB).

### Separator 30

Depending on the type of lithium secondary battery 100, the separator 30 may be between the positive electrode 10 and the negative electrode 20. As the separator 30, at least one of polyethylene, polypropylene, polyvinylidene fluoride, or a multilayered film of two or more layers thereof may be included, and a mixed multilayered film such as a polyethylene/polypropylene two-layer separator, a polyethylene/polypropylene/polyethylene three-layer separator, or a polypropylene/polyethylene/polypropylene three-layer separator may also be included.

The separator 30 may include a porous substrate and a coating layer containing an organic material, an inorganic material, or a combination thereof, located on one surface or both surfaces of the porous substrate.

The porous substrate may be or include a polymer film formed of or including any one of a polymer or a copolymer or a mixture of two or more of polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, a polyphenylene oxide, a cyclic olefin copolymer, polyphenylene sulfide, polyethylene naphthalate, a glass fiber, Teflon, and polytetrafluoroethylene.

The organic material may include a polyvinylidene fluoride-based polymer or a (meth)acrylic-based polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or may be in a form in which a coating layer containing an organic material and a coating layer containing an inorganic material are stacked together.

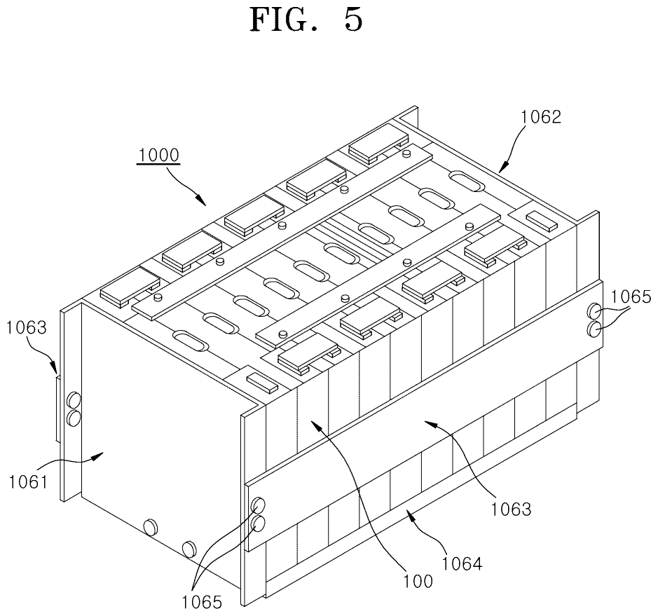

FIG. 5 is a schematic view illustrating a battery module, according to one example embodiment. Referring to FIG. 5, a battery module 1000 according to the present disclosure may include a plurality of battery cells 100 (for example, including the lithium secondary battery 100 described above with respect to FIGS. 1 to 4) arranged in one direction, and a housing 1061, 1062, 1063, and 1064 in which the plurality of battery cells 100 are accommodated.

The housing 1061, 1062, 1063, and 1064 may include a pair of end plates 1061 and 1062 facing wide surfaces of the battery cells 100, side plates 1063 that connect the pair of end plates 1061 and 1062, and a bottom plate 1064. The side plates 1063 may support side surfaces of the battery cell 100, and the bottom plate 1064 may support a bottom surface of the battery cell 100. In addition, the pair of end plates 1061 and 1062, the side plates 1063, and the bottom plate 1064 may be connected by a plurality of members such as bolts 1065.

The battery cell 100 (for example, including the lithium secondary battery 100 described above with respect to FIGS. 1 to 4) according to one example embodiment with reference to FIGS. 1 to 4 and/or the battery module 1000 including the plurality of battery cells 100 are described in detail above. Hereinafter, a method for improving heat transfer inside and outside the battery cell 100 and/or the battery module 1000 in which a plurality of battery cells 100 are located close to each other is described below.

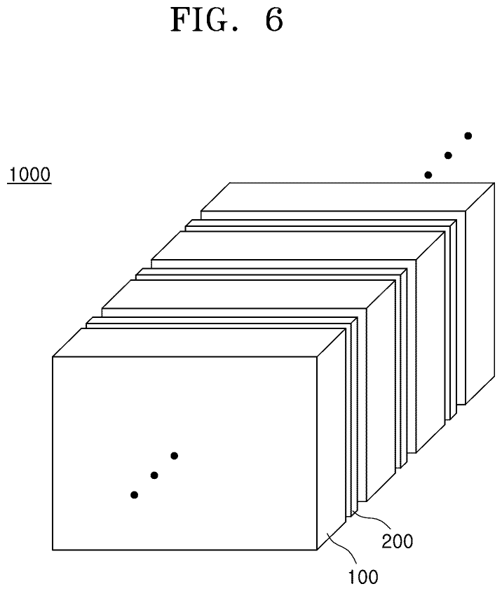

FIG. 6 is a perspective view of the battery cell according to one embodiment.

FIG. 6 schematically illustrates the plurality of battery cells 100 located inside the battery module 1000 described in FIG. 5. In FIG. 6, for convenience of explanation, the housing 1061, 1062, 1063, and 1064 accommodating the battery cells 100 is omitted.

The battery module 1000 may include the plurality of battery cells 100 arranged in parallel, and electrically connected in series or in parallel. Although FIG. 6 shows an example in which the battery module 1000 includes four battery cells 100, the battery module 1000 according to one example embodiment may include a larger number, or a smaller number, of battery cells 100. The number of battery cells 100 included in the battery module 1000 may vary depending on applications to which the battery module 1000 is applied.

The battery module 1000 may further include one or more insulation sheets 200. The insulation sheet 200 may be provided at one side, or on both sides, of the battery cell 100. For example, the insulation sheet 200 may be provided in a location between two battery cells 100. Alternatively, the insulation sheet 200 is provided in at least one of a plurality of locations between the plurality of battery cells 100. Alternatively, for example, the insulation sheet 200 may be provided between the housing 1061, 1062, 1063, and 1064 and the battery cell 100.

The insulation sheet 200 may insulate heat generated from the battery cell 100 located on one side of the insulation sheet 200. For example, the insulation sheet 200 may hinder or block heat from being transferred from one battery cell 100 to another battery cell 100 adjacent to the corresponding battery cell.

Meanwhile, the insulation sheet 200 may have a thin thickness and tension-bearing form such as a thin plate, a thin film, or a sheet. Accordingly, the insulation sheet 200 may be readily applied even to a narrow space such as a location between two battery cells 100, or between the battery cell 100 and the housing 1061, 1062, 1063, and 1064. For example, the insulation sheet 200 may be bonded to one surface of the battery cell 100 through an adhesive. Alternatively, the insulation sheet 200 may be fixed to the battery cells 100 by being inserted between two battery cells 100.

Therefore, for example, even when a thermal runaway phenomenon occurs inside the battery module 1000, heat transfer between the battery cells 100 can be reduced or prevented, and the safety of the battery cell 100 and/or the battery module 1000 can be improved.

Hereinafter, a structure of the insulation sheet 200 is described in detail below.

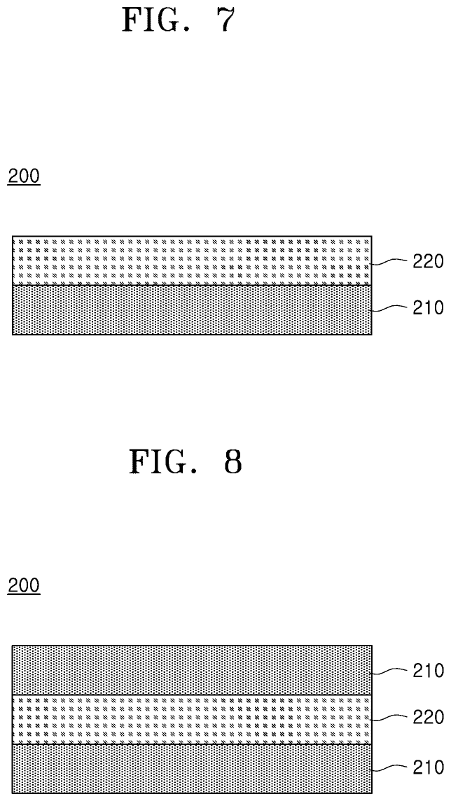

FIG. 7 is a cross-sectional view of an insulation sheet, according to one example embodiment. In FIG. 7, 200 refers to the insulation sheet described above with respect to FIG. 6. The insulation sheet 200 according to one example embodiment may include a first layer 210 and a second layer 220.

The first layer 210 may be a base of the insulation sheet 200. The first layer 210 may maintain a shape of the insulation sheet 200. In addition, the first layer 210 may be configured as a barrier that hinders or blocks heat diffusion. Due to the characteristics of the insulation sheet 200, components included in the insulation sheet 200 may be configured to not be deformed by heat or cause damage to the adjacent battery cell 100 due to heat. Accordingly, the insulation sheet 200 has an insulation property and/or heat resistance property while maintaining a shape thereof.

For example, the first layer 210 may be or include at least one, or a mixture of at least two, of mica, a fiber, vermiculite, talc, diatomaceous earth, bentonite, silica, sericite, kaolin, polyimide, and polyethylene terephthalate.

The second layer 220 may be configured as an insulating layer that allows the insulation sheet 200 to have thermal insulation property. The second layer 220 can reduce or suppress heat diffusion from one battery cell 100 to another battery cell 100 adjacent to the battery cell 100.

For example, the second layer 220 may be or include at least one, or a mixture of at least two, of aerogel, wet silica, dry silica, polyurethane, polystyrene, polyethylene, and polyester.

The second layer 220 may be stacked on at least one surface of the first layer 210. In this case, the second layer 220 may be stacked on one surface of the first layer 210 while in contact with the one surface of the first layer 210. Alternatively, the second layer 220 may be stacked on one surface of the first layer 210 while being spaced apart from one surface of the first layer 210.

The second layer 220 may be or include, for example, a sheet. The second layer 220 may be formed by being attached to the first layer 210.

Alternatively, the second layer 220 may be or include, for example, a slurry or solution. The second layer 220 may be formed by being coated, sprayed, and/or applied onto the first layer 210.

With this configuration, the insulation sheet 200 according to one example embodiment can reduce or prevent heat transfer between a plurality of adjacent battery cells 100.

FIG. 8 is a cross-sectional view of an insulation sheet, according to one example embodiment. In FIG. 8, 200 refers to the insulation sheet described in FIGS. 6 and 7. The insulation sheet 200 according to one example embodiment may include a first layer 210 and a second layer 220.

As shown in FIG. 8, the insulation sheet 200 may include a configuration formed by alternately stacking the first layer 210 and the second layer 220. For example, the insulation sheet 200 may include two first layers 210, the second layer 220 being located between the two first layers 210.

With this configuration, the first layer 210 according to one example embodiment may further support the second layer 220. In addition, the first layer 210 can reduce or prevent the second layer 220 from being damaged from the outside.

For example, the insulation sheet 200 according to one example embodiment may provide an improved effect by further including an additional additive for the second layer 220 as follows.

The additive may be or include at least one of a leveling agent, a defoamer, a dispersing agent, and a combination (a mixture) thereof. The additive may be added to the second layer 220 to improve uniformity of a coating of the second layer 220 with respect to the first layer 210. Accordingly, the second layer 220 can improve a thermal insulation property and/or a fire resistance property by increasing yield, removing micropores in a coating layer, and the like.

For example, the leveling agent can have the uniformity improvement of the coating layer, and defect generation reduction or prevention effects. Therefore, the leveling agent can coat the aerogel more uniformly and increase the density of the aerogel.

For example, the defoamer can remove bubbles in the aerogel coating layer to increase density of the second layer 220.

For example, the dispersing agent can improve a degree of dispersion of silica particles in the aerogel to increase the density of the second layer 220. As the density of the aerogel in the second layer 220 increases, the thermal insulation property and/or the fire resistance property of the insulation sheet 200 can be improved. In addition, the insulation sheet 200 can have a uniform coating layer, thereby increasing a yield thereof.

The additive may be or include at least one of a silicone-based polymer, a non-silicone-based polymer, a polyester-based polymer, a fluorine-based polymer, and a combination thereof. The additive may include commercially available products.

Alternatively, the additive may be or include an impact-resistant resin. The additive may be added to the second layer 220 to improve impact resistance property of the second layer 220. Accordingly, the second layer 220 may not be damaged even during heat transfer.

The impact-resistant resin may be or include at least one, or a mixture of at least two, of an elastomer, a polyurethane-based or silicone-based resin, and a hyperbranch.

For example, the second layer 220 may include about 1 wt % to about 10 wt % of the additive. Alternatively, for example, the second layer 220 may include 2 wt % to 8 wt % of the additive. Alternatively, for example, the second layer 220 may include 3 wt % to 6 wt % of the additive. Alternatively, for example, the second layer 220 may include 3 wt % to 5 wt % of the additive. Alternatively, for example, the second layer 220 may include 4 wt % to 5 wt % of the additive.

For example, the second layer 220 may include about 40 wt % to about 80 wt % of an insulating material and about 3 wt % to about 5 wt % of the additive. For example, the second layer 220 may include about 40 wt % to about 80 wt % of the insulating material and about 3 wt % to about 5 wt % of the impact-resistant resin.

Alternatively, the second layer 220 may include about 42 wt % to about 80 wt % of the insulating material and about 1 wt % to about 10 wt % of the impact-resistant resin. Alternatively, the second layer 220 may include 65 wt % to 80 wt % of the insulating material and 1 wt % to 10 wt % of the impact-resistant resin. Alternatively, the second layer 220 may include 42 wt % to 65 wt % of the insulating material and 1 wt % to 10 wt % of the impact-resistant resin.

Alternatively, the second layer 220 may include about 42 wt % to about 80 wt % of the insulating material and about 2 wt % to about 8 wt % of the impact-resistant resin. Alternatively, the second layer 220 may include 65 wt % to 80 wt % of the insulating material and 2 wt % to 8 wt % of the impact-resistant resin. Alternatively, the second layer 220 may include 42 wt % to 65 wt % of the insulating material and 2 wt % to 8 wt % of the impact-resistant resin.

Alternatively, the second layer 220 may include about 42 wt % to about 80 wt % of the insulating material and about 3 wt % to about 5 wt % of the impact-resistant resin. Alternatively, the second layer 220 may include 65 wt % to 80 wt % of the insulating material and 3 wt % to 5 wt % of the impact-resistant resin. Alternatively, the second layer 220 may include 42 wt % to 65 wt % of the insulating material and 3 wt % to 5 wt % of the impact-resistant resin.

Alternatively, the second layer 220 may include about 42 wt % to about 80 wt % of the insulating material and about 3 wt % to about 4 wt % of the impact-resistant resin. Alternatively, the second layer 220 may include 65 wt % to 80 wt % of the insulating material and 4 wt % to 5 wt % of the impact-resistant resin.

FIG. 9 is a cross-sectional view of an insulation sheet, according to one example embodiment. In FIG. 9, 200 refers to the insulation sheet described above with respect to FIGS. 6 to 8. The insulation sheet 200 according to one example embodiment may include a first layer 210, a second layer 220, and a third layer 230.

The third layer 230 may have a heat storage property.

The third layer 230 may include a phase change material (PCM). For example, the phase change material may include at least one, or a mixture of at least two, of paraffin, an inorganic salt, a salt hydrate, a carboxylic acid, and a sugar alcohol.

The third layer 230 may be formed in a sheet shape in a solid state. The third layer 230 may be formed on one surface of the second layer 220.

For example, the insulation sheet 200 may include one or more first layers 210, one or more second layers 220 stacked above the first layer 210, and one or more third layers 230 stacked on one surface of the second layer 220.

For example, as shown in FIG. 9, the insulation sheet 200 may include the first layer 210, the second layer 220 formed in contact with one surface of the first layer 210, and the third layer 230 formed in contact with one surface of the second layer 220.

Alternatively, the insulation sheet 200, unlike the illustration in FIG. 9, may include the first layer 210, the third layer 230 formed in contact with one surface of the first layer 210, and the second layer 220 formed in contact with one surface of the third layer 230.

In examples, the third layer 230 may reduce or prevent heat from being transferred toward the second layer 220 from inside and/or outside through its heat storage property. The third layer 230 may reduce or prevent an organic binder located inside the second layer 220 from being damaged by heat transfer. Accordingly, the third layer 230 can improve the thermal conductivity of the insulation sheet 200.

In an example, unlike the example illustrated in FIG. 9, the third layer 230 may be formed in a solution or a slurry state, and/or formed in a powder form in a solid state. The third layer 230 may be added to the second layer 220 and mixed with the second layer 220. For example, the third layer 230 may be added to a slurry including the second layer 220 and a binder and coated on the first layer 210. In this case, the binder may be included to aid mixing and adhesion of the third layer 230 to the second layer 220. The binder may include, for example, a PVA-based binder. A mixture layer including the second layer 220, the third layer 230, and the binder may include, for example, about 40 wt % to about 60 wt % of the second layer 220, about 5 wt % to about 15 wt % of the third layer 230, and about 30 wt % to about 50 wt % of the binder.

In this case, most of the organic binder included in the second layer 220 may not be damaged as heat transfer from the outside is reduced or prevented by the third layer 230 from reaching the second layer 220. Accordingly, the third layer 230 can improve thermal conductivity of the insulation sheet 200.

With this configuration, the insulation sheet 200 according to one example embodiment may provide the insulation sheet 200 with the improved thermal conductivity.

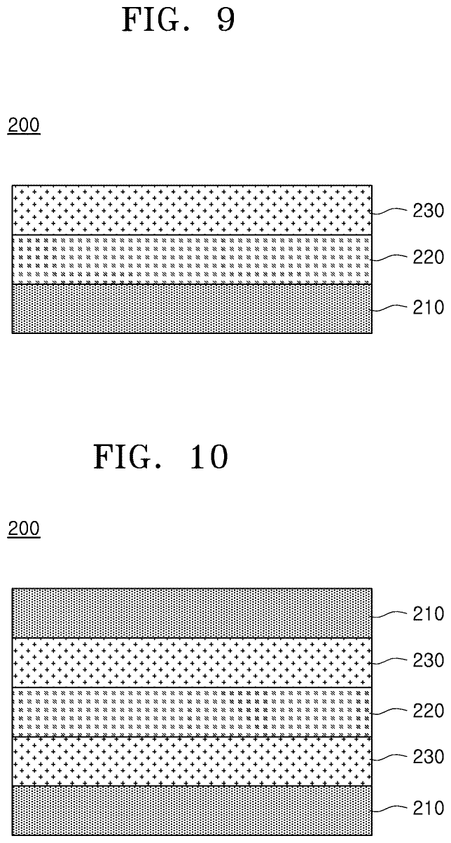

FIG. 10 is a cross-sectional view of an insulation sheet, according to one example embodiment. In FIG. 10, 200 refers to the insulation sheet described above with respect to FIGS. 6 to 9. The insulation sheet 200 according to one example embodiment may include a first layer 210, a second layer 220, and a third layer 230.

The insulation sheet 200, as shown in FIG. 10, may include a configuration formed by alternately stacking two or more first layers 210, two or more second layers 220, and the third layer 230. For example, the insulation sheet 200 may include the first layer 210, the third layer 230 formed by being stacked on one surface of the first layer 210, and the second layer 220 formed by being stacked on one surface of the third layer 230, further include the third layer 230 formed by being stacked on one surface of the second layer 220, and further include the first layer 210 formed by being stacked on one surface of the third layer 230. That is, the insulation sheet 200 may include the second layer 220, the third layers 230 formed on both surfaces of the second layer 220, and the first layers 210 having both surfaces covering these layers.

With this configuration, the insulation sheet 200 according to one example embodiment may have better support strength and improved thermal conductivity.

Alternatively, unlike the example shown in FIG. 10, the insulation sheet 200 may include a mixture layer located between two second layers 220 and two first layers 210 and formed by mixing the second layer 220 and the third layer 230.

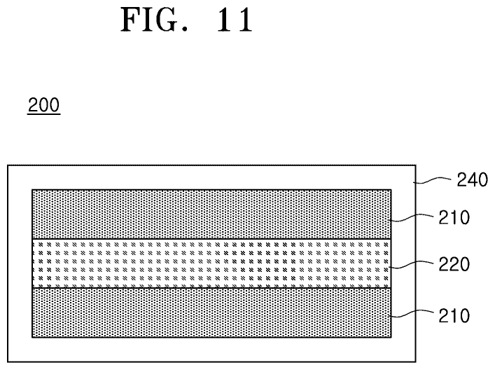

FIG. 11 is a cross-sectional view of an insulation sheet according to one example embodiment. In FIG. 11, 200 refers to the insulation sheet described above with respect to FIGS. 6 to 10. The insulation sheet 200 according to one example embodiment may include a first layer 210, a second layer 220, and a coating layer 240. The coating layer 240 may be a coating layer formed on an outer perimeter of the insulation sheet 200. The coating layer 240 may have a fire resistance property with which it can withstand heat during heat transfer. In addition, the coating layer 240 can increase the mechanical strength of the insulation sheet 200 and/or reduce dust generated from the insulation sheet 200.

For example, the coating layer 240 may include a fiber. For example, the coating layer 240 may be or include at least one, or a mixture of at least two, of glass wool, rock wool, glass fiber, gypsum fiber, silica fiber, alumina fiber, zirconia fiber, and carbon fiber, which are inorganic materials in the form of fibers. Alternatively, for example, the coating layer 240 may be or include at least one, or a mixture of at least two, of gold, silver, iron, steel, aluminum, beryllium, tungsten, molybdenum, and stainless steel, which are formed in the form of a fiber and are metal materials in the form of a fiber.

As shown in FIG. 11, the coating layer 240 may be formed by surrounding any one surface of an outer perimeter of at least one of the insulation sheets 200 described above with respect to FIGS. 6 to 10. For example, the coating layer 240 may be formed only on one surface of the outer perimeter of the insulation sheet 200. One surface of the outer perimeter may be, for example, a surface substantially perpendicular to a direction in which the first layer 210 and the second layer 220 are stacked, and may be one of four side surfaces of the insulation sheet 200. Alternatively, for example, the coating layer 240 may be formed on at least two surfaces of the outer perimeter of the insulation sheet 200. At least two surfaces of the outer perimeter may be, for example, surfaces substantially perpendicular to the direction in which the first layer 210 and the second layer 220 are stacked, and may be at least two of the four side surfaces of the insulation sheet 200. In this case, at least two surfaces of the outer perimeter may be located to face each other, or may be located adjacent to each other. Alternatively, for example, the coating layer 240 may be formed by surrounding substantially the entire surface of the insulation sheet 200. The entire surface of the insulation sheet 200 may include the four side surfaces of the insulation sheet 200 and a top surface and a bottom surface of the insulation sheet 200. At least one of the top and bottom surfaces of the insulation sheet 200 may be one surface of the first layer 210.

Accordingly, for example, the insulation sheet 200 may include the second layer 220, the first layers 210 formed on both surfaces of the second layer 220, and the coating layer 240 formed on at least one surface of the outer surfaces of a stacked structure including the first layer 210 and the second layer 220.

With this structure, the insulation sheet 200 according to one example embodiment can improve a dust effect that may occur from the insulation sheet 200 and/or components included in the insulation sheet 200. In addition, the insulation sheet 200 may have an improved fire resistance property and increased mechanical strength, thereby reducing or preventing damage to the insulation sheet 200 even during heat transfer.

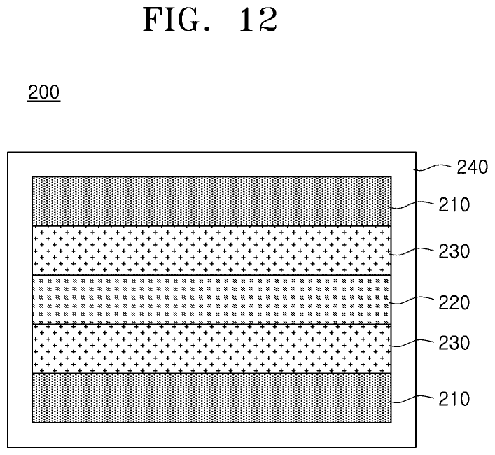

FIG. 12 is a cross-sectional view of an insulation sheet, according to one example embodiment. In FIG. 12, 200 refers to the insulation sheet described above with respect to FIGS. 6 to 11. The coating layer 240 described in FIG. 11 may be applicable to any insulating sheet described above with respect to FIGS. 6 to 11. For example, the coating layer 240 may be applicable to the insulation sheet described above with respect to FIG. 10. As shown in FIG. 12, the insulation sheet 200 may include the second layer 220, the third layers 230 formed on both surfaces of the second layer 220, the first layer 210 formed on one surface of each of the third layers 230, and the coating layer 240 surrounding at least a part of an outer surface of a laminate including the first layers 210, the second layer 220, and the third layers 230.

In this way, because the insulation sheet 200 according to one example embodiment further includes the coating layer 240, it is possible to provide the insulation sheet 200 with the fire resistance property, mechanical property, and dust improvement effects.

The battery cell 100 and/or the battery module 1000 according to one example embodiment of the present disclosure may be applicable to automobiles, mobile phones, and/or various types of electrical devices, but the present disclosure is not limited thereto.

Hereinafter, examples and comparative examples of the present disclosure are described below. However, the following examples are only examples of the present disclosure, and the present disclosure is not limited to following example embodiments.

### Example 1

### Preparation of Composition for Second Layer 220

Polyvinyl alcohol (Sigma Aldrich, PVA) was added as a binder to ultrapure water as a solvent and mixed at 30 rpm with an open blade and 700 rpm with a disperser blade to prepare a first mixed solution. Aerogel (BET specific surface area 800 m²/g) was added to the first mixed solution and mixed at 70 rpm with an open blade and 1500 rpm with a disperser blade to prepare a second mixed solution. Glass wool was added to the second mixed solution and mixed at 30 rpm with an open blade and 1200 rpm with a disperser blade to prepare a third mixed solution. An impact-resistant resin was added to the third mixed solution to prepare a composition for the second layer 220. A planetary mixer (DIENTEK, PT-005) was used during mixing.

The prepared composition for the second layer 220 was in a slurry form and solid content was 42 wt % aerogel, 50 wt % glass wool, 5 wt % polyvinyl alcohol, and 3 wt % silicone-based impact-resistant resin of Shin-Etsu's KE 441K-T.

### Manufacturing of Insulation Sheet 200

The prepared composition for the second layer 220 was applied on a mica sheet (Famica, Muscovite) with a thickness of 0.2 mm as the first layer 210, and another mica sheet (Famica, Muscovite) with a thickness of 0.2 mm as the first layer 210 was stacked on the composition for the second layer 220 and coated using a roll rolling method. Then, a stacked base sheet was manufactured in the order of first layer 210-second layer 220-first layer 210 by being dried at 60° C. for 24 hours.

A thickness of the second layer 220 of the manufactured insulation sheet 200 was 2.0 mm.

### Example 2

The insulation sheet 200 was manufactured in the same manner as in Example 1, with a difference that the solid content in the composition for the second layer 220 was changed to 42 wt % aerogel, 50 wt % glass wool, 5 wt % polyvinyl alcohol, and 3 wt % silicone-based impact-resistant resin of Dow Silicone's DC-211.

### Example 3

The insulation sheet 200 was manufactured in the same manner as in Example 1, with a difference that the solid content in the composition for the second layer 220 was changed to 42 wt % aerogel, 50 wt % glass wool, 5 wt % polyvinyl alcohol, and 3 wt % urethane resin CB of Noroo Paint's.

### Example 4

The insulation sheet 200 was manufactured in the same manner as in Example 1, with a difference that the solid content in the composition for the second layer 220 was changed to 65 wt % aerogel, 25 wt % glass wool, 5 wt % polyvinyl alcohol, and 5 wt % silicone-based impact-resistant resin of Shin-Etsu's KE 441K-T.

### Example 5

The insulation sheet 200 was manufactured in the same manner as in Example 1, with a difference that the solid content in the composition for the second layer 220 was changed to 80 wt % aerogel, 10 wt % glass wool, 5 wt % polyvinyl alcohol, and 5 wt % silicone-based impact-resistant resin of Shin-Etsu's KE 441K-T.

### Comparative Example 1

The insulation sheet 200 was manufactured in the same manner as in Example 1, with a difference that the solid content in the composition for the second layer was changed to 45 wt % aerogel, 50 wt % glass wool, and 5 wt % polyvinyl alcohol.

### Comparative Example 2

The insulation sheet 200 was manufactured in the same manner as in Example 1, with a difference that the solid content in the composition for the second layer was changed to 70 wt % aerogel, 25 wt % glass wool, and 5 wt % polyvinyl alcohol.

### Comparative Example 3

The insulation sheet 200 was manufactured in the same manner as in Example 1, with a difference that the solid content in the composition for the second layer was changed to 85 wt % aerogel, 10 wt % glass wool, and 5 wt % polyvinyl alcohol.

Table 1 below shows the compositions and corresponding physical properties of Examples 1 to 5 and Comparative Examples 1 to 3.

TABLE 1

| | Aerogel-containing layer | | | | Thermal | Flame | |
|---|---|---|---|---|---|---|---|
| | | | | Impact- | insulation | resis- | Ball |
| | Aero- | Glass | Bin- | resistant | property | tance | drop |
| | gel | wool | der | resin | (° C.) | (s) | (mm) |
| Example 1 | 42 | 50 | 5 | 3 | 89.9 | 700 | 230 |
| Example 2 | 42 | 50 | 5 | 3 | 87.3 | 705 | 200 |
| Example 3 | 42 | 50 | 5 | 3 | 88.8 | 703 | 210 |
| Example 4 | 65 | 25 | 5 | 5 | 81.2 | 711 | 240 |
| Example 5 | 80 | 10 | 5 | 5 | 75.1 | 713 | 210 |
| Comparative | 45 | 50 | 5 | — | 87.3 | 702 | 100 |
| Example 1 | | | | | | | |
| Comparative | 70 | 25 | 5 | — | 81.1 | 710 | 70 |
| Example 2 | | | | | | | |
| Comparative | 85 | 10 | 5 | — | 77.2 | 709 | 40 |
| Example 3 | | | | | | | |

The physical properties of the insulation sheets manufactured through Examples 1 to 5 and Comparative Examples 1 to 3 were evaluated as indicated below.

(1) Thermal insulation property evaluation: The manufactured insulation sheet was cut to a width of 232 mm and a height of 115 mm to prepare specimens, and each of the insulation sheets was placed between a pair of 1 mm thick aluminum plates facing each other, put on a heat press, and maintained at a starting temperature of 40° C. with an upper plate heated to 350° C. and a lower plate unheated. Then, a pressure of 20 kN was applied to the lower plate of the heat press and a temperature of the lower plate of the heat press was measured after 11 minutes. The lower the temperature of the lower plate, the better the thermal insulation property of the insulation sheet.

(2) Flame resistance (unit: seconds): The manufactured insulation sheet was cut to a width of 100 mm and a height of 70 mm to prepare specimens, and a temperature sensor was attached to the insulation sheet. A torch capable of spraying flame to the attached specimen was used to apply flame so that the temperature of a surface of the insulation sheet reached 1200° C. At this time, a time until the exterior of the insulation sheet cracked and collapsed was checked. The longer the time, the better the resistance to passing of flame.

(3) Ball drop: After the manufactured insulation sheet was cut to a width of 100 mm and a height of 100 mm to prepare specimens and clamped in a jig, a 200 g SUS (stainless steel) ball was dropped vertically, while adjusting a height of the ball drop, to check the height at which no damage occurred on a surface.

An insulation sheet and/or a secondary battery module including the insulation sheet according to one example embodiment can improve heat transfer between adjacent cells.

An insulation sheet and/or a secondary battery including the insulation sheet according to one example embodiment can have improved fire resistance and/or thermal insulating properties.

An insulation sheet and/or a secondary battery including the insulation sheet according to one example embodiment can have improved thermal conductivity.

An insulation sheet according to one example embodiment can reduce or prevent damage even when heat transfer occurs.

An insulation sheet according to one example embodiment can have a dust reduction effect.

Although the example embodiments of the present disclosure have been described above, the present disclosure is not limited thereto and various modifications can be made within the scope of the claims, detailed description, and accompanying drawings, which also fall within the scope of the present disclosure.

What is claimed is:

1. An insulation sheet comprising:
one or more first layers; and
one or more second layers alternately stacked with the one or more first layers,
wherein the one or more second layers comprise an insulating material and an impact-resistant resin.

2. The insulation sheet of claim 1, wherein the one or more second layers have the one or more first layers formed on both surfaces thereof.

3. The insulation sheet of claim 1, wherein the one or more second layers comprise about 40 wt % to about 80 wt % of the insulating material and about 1 wt % to about 10 wt % of the impact-resistant resin.

4. The insulation sheet of claim 1, wherein the one or more first layers comprise at least one, or a mixture of at least two, of mica, muscovite, talc, diatomaceous earth, bentonite, silicone, magnesite, kaolin, polyimide, and polyethylene terephthalate.

5. The insulation sheet of claim 1, wherein the one or more second layers comprise at least one, or a mixture of at least two, of aerogel, wet silica, dry silica, polyurethane, polystyrene, polyethylene, and polyester.

6. The insulation sheet of claim 1, wherein the impact-resistant resin comprises at least one, or a mixture of at least two, of elastomer, a polyurethane-based resin, a silicone-based resin, and hyperbranch.

7. The insulation sheet of claim 1, further comprising one or more third layers formed on one surface of the one or more second layers and including a phase change material (PCM).

8. The insulation sheet of claim 7, wherein the one or more third layers are formed on both surfaces of the one or more second layers to form a laminate together with the one or more second layers, and the one or more first layers are formed on both surfaces of the laminate.

9. The insulation sheet of claim 7, wherein the one or more third layers comprise at least one, or a mixture of at least two, of paraffin, inorganic salts, salt hydrates, carboxylic acids, and sugar alcohols.

10. A battery module comprising:
a plurality of battery cells;
an insulation sheet located in at least one of a plurality of locations between the plurality of battery cells; and
a housing in which the battery cells and the insulation sheet are accommodated;
wherein the insulation sheet comprises one or more first layers, and one or more second layers alternately stacked with the one or more first layers, wherein the one or more second layers comprise an insulating material and an impact-resistant resin.

11. The battery module of claim 10, wherein the one or more second layers have the one or more first layers formed on both surfaces thereof.

12. The battery module of claim 10, wherein the one or more second layers comprise about 40 wt % to about 80 wt % of the insulating material and about 1 wt % to about 10 wt % of the impact-resistant resin.

13. The battery module of claim 10, wherein the one or more first layers comprise at least one, or a mixture of at least two, of mica, muscovite, talc, diatomaceous earth, bentonite, silicone, magnesite, kaolin, polyimide, and polyethylene terephthalate.

14. The battery module of claim 10, wherein the one or more second layers comprise at least one, or a mixture of at least two, of an aerogel, wet silica, dry silica, polyurethane, polystyrene, polyethylene, and polyester.

15. The battery module of claim 10, wherein the impact-resistant resin comprises at least one, or a mixture of at least two, of an elastomer, a polyurethane-based resin, a silicone-based resin, and a hyperbranch.
